(19) United States
(12) Patent Application Publication
(10) Pub. No.: US 2025/0062932 A1
(43) Pub. Date: Feb. 20, 2025

(54) PRIORITY DETERMINATION APPARATUS, PRIORITY DETERMINATION METHOD AND PROGRAM

(71) Applicant: NIPPON TELEGRAPH AND TELEPHONE CORPORATION, Tokyo (JP)

(72) Inventors: Satoshi NISHIYAMA, Tokyo (JP); Hiroki KANO, Tokyo (JP)

(21) Appl. No.: 18/725,956

(22) PCT Filed: Feb. 17, 2022
(86) PCT No.: PCT/JP2022/006483

§ 371 Date: Jul. 1, 2024

(51) Int. Cl. H04L 12/46

(52) U.S. Cl. CPC H04L 12/4641

(57) ABSTRACT

A priority determination device includes a collection unit configured to collect a usage status of identification information for virtually separating a network from each of a plurality of transfer devices distributed in a plurality of domains; and a determination unit configured to determine a priority of use in each of the plurality of domains for each value which is available as the identification information, based on the collected usage status, which enables effective use of identification information of virtually separated networks.

### TECHNICAL FIELD

The present invention relates to a priority determination device, a priority determination method, and a program.

### BACKGROUND ART

It may be desired to connect networks between multiple business entity domains using limited ID resources for layer 2 virtual isolation protocol IDs such as VLAN IDs. In the prior art, it is necessary to secure in advance an ID area that is available in common between domains.

Citation List

### Patent Literature

[PTL 1] Japanese Patent Application Publication No. 2018-085585

### Non Patent Literature

[NPL 1] YAMAHA, “Setting up Tag VLAN”, [online], Internet <URL: https://network.yamaha.com/setting/switch_swx/simple_smart/swi tch swx-command/tag_vlan>

### SUMMARY OF INVENTION

### Technical Problem

However, since the layer 2 virtual isolation protocol ID is also used for different services for each domain, the commonly available ID area varies over time.

If the ID area secured in advance is too large, the flexibility of IDs that can be provided by other services decreases; if the ID area is too small, it will be difficult to respond to sudden demand, and running by the operator will be required.

The present invention has been contrived to solve problems described above, and an object thereof is to enable effective deployment of identification information for virtually separating networks.

### Solution to Problem

For addressing the problems above, provided is a priority determination device, including: a collection unit configured to collect a usage status of identification information for virtually separating a network from each of a plurality of transfer devices distributed in a plurality of domains; and a determination unit configured to determine a priority of use in each of the plurality of domains for each value which is available as the identification information, based on the collected usage status.

### Advantageous Effects of Invention

Thus, it is possible to enable effective deployment of identification information of virtually separated networks.

### BRIEF DESCRIPTION OF DRAWINGS

FIG. 1 is a diagram illustrating an example of a configuration of a network system according to a first embodiment.

FIG. 2 is a diagram illustrating a hardware configuration example of an arbitration device 10 according to the first embodiment.

FIG. 3 is a flowchart illustrating one example of a processing procedure executed by the arbitration device 10 according to the first embodiment.

FIG. 4 is a diagram illustrating one example of information indicating usage status of IDs.

FIG. 5 is a diagram illustrating one example of notification information in the first embodiment.

FIG. 6 is a diagram illustrating an example of a configuration of a network system according to a second embodiment.

FIG. 7 is a flowchart illustrating one example of a processing procedure executed by an arbitration device 10 according to the second embodiment.

FIG. 8 is a diagram illustrating one example of notification information in the second embodiment.

FIG. 9 is a diagram illustrating an example of a configuration of a network system according to a third embodiment.

FIG. 10 is a flowchart illustrating one example of a processing procedure executed by an arbitration device 10 according to the third embodiment.

FIG. 11 is a diagram illustrating one example of notification information in the third embodiment.

### DESCRIPTION OF EMBODIMENTS

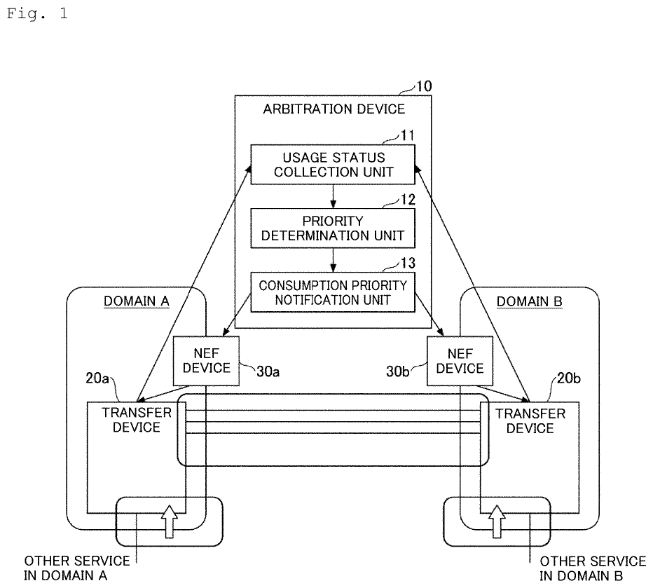

Embodiments of the present invention will be described below with reference to the drawings. FIG. 1 is a diagram illustrating an example of a configuration of a network system according to a first embodiment. In FIG. 1, the network system includes, for example, a transfer device 20a, a transfer device 20b, an NEF device 30a, an NEF device 30b, and an arbitration device 10. Hereinafter, if the transfer device 20a and the transfer device 20b are not particularly distinguished, they will be referred to as “transfer device 20.” Furthermore, if the NEF device 30a and the NEF device 30b are not particularly distinguished, they will be referred to as “NEF device 30.”

The transfer device 20a is, for example, a switch or a router within a business entity domain A (hereinafter referred to as “domain A”). The NEF device 30a is a device that functions as a domain A's network exposure function (NEF). The NEF device 30a is installed at the boundary of the domain A, and serves as a point of contact for requests from outside the domain A.

The transfer device 20b is, for example, a switch or a router within a business entity domain B (hereinafter referred to as “domain B”) different from the business entity domain B. The NEF device 30b is a device that functions as a domain B′s network exposure function (NEF). The NEF device 30b is installed at the boundary of the domain B, and serves as a point of contact for requests from outside the domain B.

That is, the transfer device 20a and the transfer device 20b are distributed over multiple domains (domains A and B) in the present embodiment.

The transfer device 20a and the transfer device 20b are interconnected by a VLAN. As an ID of the VLAN (hereinafter simply referred to as “ID”), a value that is commonly available in both domains to the extent that it can be used as the ID is employed. Each transfer device 20 also accommodates VLANs of other services in the domain to which it belongs.

The arbitration device 10 is one or more computers connected to each transfer device 20 and each NEF device 30 via a network. The arbitration device 10 performs arbitration regarding IDs used for VLANs. More specifically, the arbitration device 10 collects the usage status (used status) of IDs in each domain, and notifies each domain of IDs that should be preferentially used with respect to other services in each domain. Accordingly, the ID can be used effectively.

The arbitration device 10 includes a usage status collection unit 11, a consumption priority determination unit 12, and a consumption priority notification unit 13. Details of each unit will be appreciated in the description of the processing procedures.

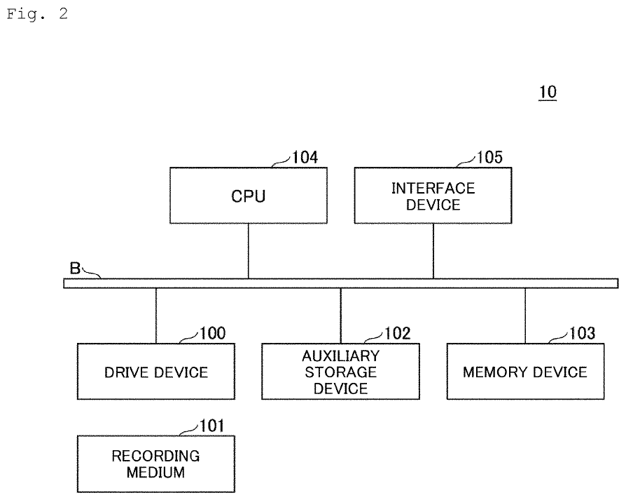

FIG. 2 is a diagram illustrating a hardware configuration example of the arbitration device 10 according to the first embodiment. The arbitration device 10 shown in FIG. 2 includes a drive device 100, an auxiliary storage device 102, a memory device 103, a CPU 104, and an interface device 105, which are connected with each other via a bus B.

A program that implements processing in the arbitration device 10 is provided by a recording medium 101 such as a CD-ROM. When the recording medium 101 storing the program is set in the drive device 100, the program is installed from the recording medium 101 to the auxiliary storage device 102 via the drive device 100. However, the program does not necessarily have to be installed from the recording medium 101 and may be downloaded from another computer via a network. The auxiliary storage device 102 stores the installed program as well as necessary files and data.

The memory device 103 reads and stores the program from the auxiliary storage device 102 when an instruction for activating the program is issued. The CPU 104 executes functions relevant to the arbitration device 10 according to the program stored in the memory device 103. The interface device 105 is used as an interface to connect to the network.

Meanwhile, the usage status collection unit 11, the consumption priority determination unit 12, and the consumption priority notification unit 13 illustrated in FIG. 1 are implemented by processing of causing the CPU 104 to execute one or more programs installed in the arbitration device 10.

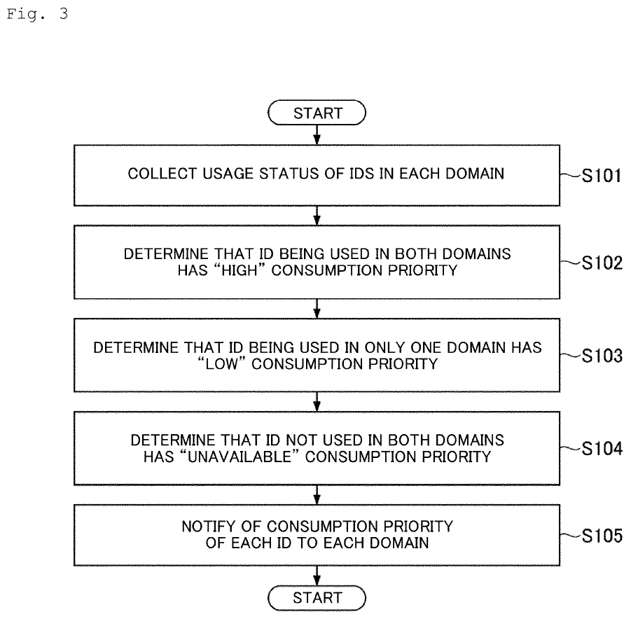

Hereinafter, a processing procedure executed by the arbitration device 10 will be described. FIG. 3 is a flowchart illustrating one example of a processing procedure executed by the arbitration device 10 according to the first embodiment. The processing procedure shown in FIG. 3 is executed a plurality of timings, for example, periodically.

In step S101, the usage status collection unit 11 collects (obtains) information indicating usage status of IDs in each domain (information on used/released IDs) from each of the transfer device 20a and the transfer device 20b.

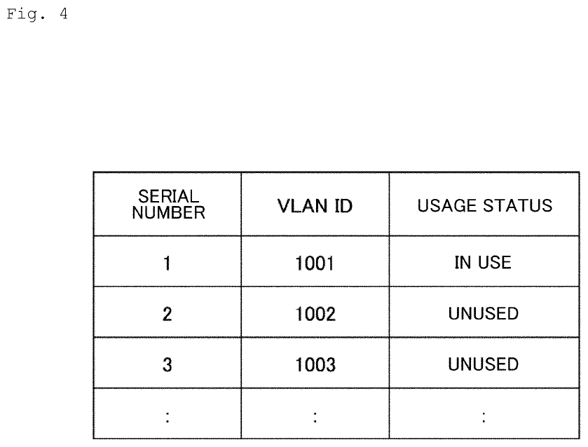

FIG. 4 is a diagram illustrating one example of information indicating usage status of IDs. As illustrated in FIG. 4, information indicating whether a value is currently being used as the ID (unused) is collected for each value included in a range to the extent that the ID can take, for each domain, in step S101. In the present embodiment, one example is shown in which the number of transfer devices 20 facing each other between the domain A and the domain B is one in each domain; however, when a plurality of transfer devices 20 face another domain in a certain domain, the usage status collection unit 11 collects information indicating the ID usage status from the plurality of transfer devices 20, and derives the usage status in the entire range of values to the extent that the ID can take based on the results.

Subsequently, the consumption priority determination unit 12 determines that a consumption priority of the ID currently in use in both domain A and domain B is “HIGH” (S102). The consumption priority refers to a priority regarding the use (consumption) of ID in the domain A and the domain B, which means that IDs should be used preferentially in descending order of consumption priority.

Subsequently, the consumption priority determination unit 12 determines that a consumption priority of the ID currently in use only in either domain A or domain B is “LOW” (S103). The consumption priority of the ID that is being used in one domain only is lower than the consumption priority of the ID that is being used in both domains (that is, it is made easier to allocate to the VLAN between two domains); this is because the ID that is being used by in one domain only becomes available for both domains if the one domain releases it. Therefore, the ID (value) with a larger number of domains in use has a higher consumption priority.

Subsequently, the consumption priority determination unit 12 determines that a consumption priority of the ID currently unused in both domain A and domain B is “UNAVAILABLE” (S104). “UNAVAILABLE” is one example of the lowest priority and means that it is unavailable (use is prohibited).

Subsequently, the consumption priority notification unit 13 transmits notification information including the consumption priority determination results in steps S102 to S104 to each domain (S105). At this time, the consumption priority notification unit 13 does not directly send the notification information to the transfer device 20 of each domain, but sends the notification information to the NEF device 30 of each domain. That is, the notification information passes through the NEF device 30. Each NEF device 30 has an interface for receiving the notification information previously installed.

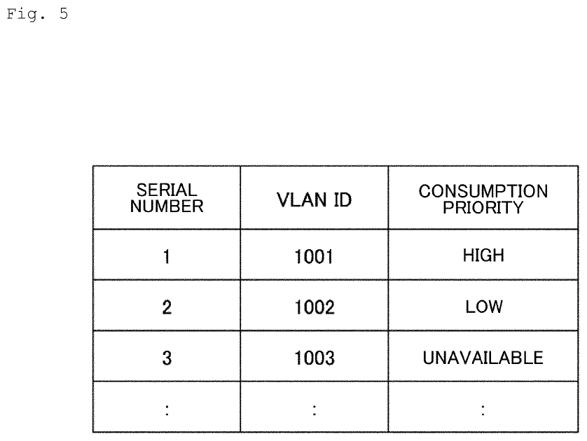

FIG. 5 is a diagram illustrating one example of notification information in the first embodiment. As illustrated in FIG. 5, the notification information includes, for each value in the range to the extent that the ID can take, the consumption priority when using the value as the ID.

The NEF device 30 of each domain evaluates the consumption priority of each ID included in the notification information and the priority of other services uniquely held within the domain by weighting, and determines whether the consumption priority included in the notification information should be adopted. By determining ID allocation based on the notification information in both domains, it is possible to reduce the possibility that an “UNAVAILABLE” ID will be used in each domain. Therefore, the ID can be reserved for layer 2 virtual separation protocols such as VLAN between domains. Accordingly, IDs can be used without waste, and limited number of IDs can be effectively deployed. That is, as compared to existing methods, IDs can be managed more efficiently and while adapting to changes. Therefore, the lead time for service provision and the frequency of scale-up can be reduced, and the workload of maintenance personnel can also be decreased.

Next, a second embodiment will be described. In the second embodiment, differences from the first embodiment will be described. Features which are not referred particularly in the second embodiment may be similar to those of the first embodiment.

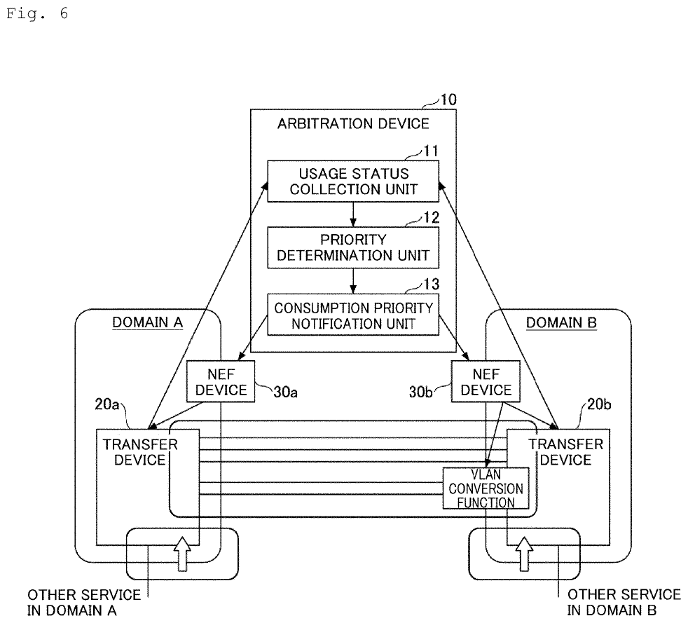

FIG. 6 is a diagram illustrating an example of a configuration of a network system according to the second embodiment. In FIG. 6, the same portions as those in FIG. 1 are designated by the same reference numerals, and the description thereof will be omitted.

In the second embodiment, a case where the transfer device 20 of each domain has a VLAN conversion function will be described. In FIG. 6, it seems that only the transfer device 20b has the VLAN conversion function, but this actually indicates that only the transfer device 20b uses the VLAN conversion function. The transfer device 20a may also have the VLAN conversion function. The VLAN conversion function is a function for converting IDs in the transfer device 20. With the VLAN conversion function, even if an ID is used in at least one of the domains, it can be allocated to a VLAN between domains. This is because, even in a domain using a specific ID, all it takes is to convert the specific ID to an ID not currently used in the domain.

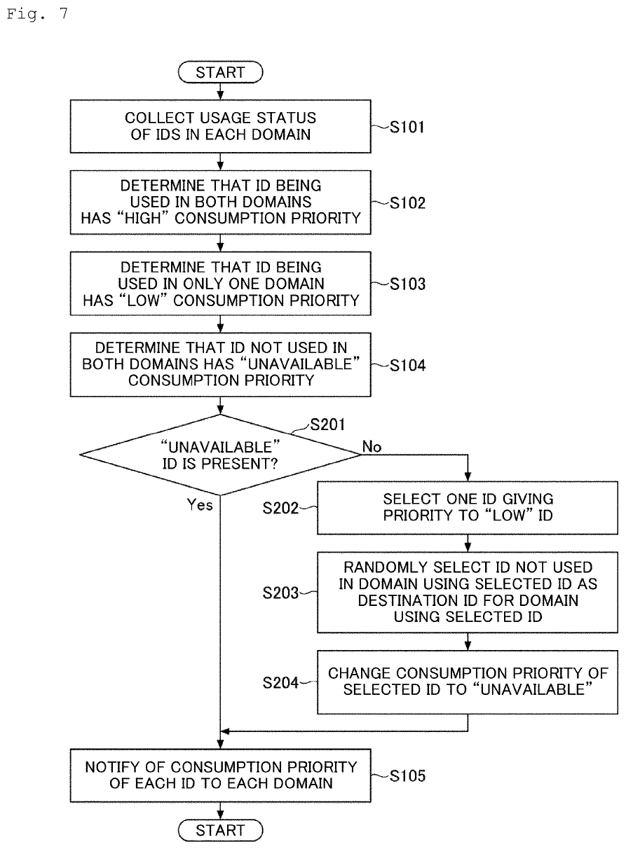

FIG. 7 is a flowchart illustrating one example of a processing procedure executed by the arbitration device 10 according to the second embodiment. In FIG. 7, the same steps as those in FIG. 3 are assigned the same step numbers, and description thereof is omitted.

Following step S104, the consumption priority determination unit 12 determines whether there is an ID whose consumption priority is “UNAVAILABLE” in the determination results up to step S104 (S201). If there is a corresponding ID (that is, if there is an ID that can be allocated between two domains) (YES in S201), step S105 is executed. In this case, the notification information having the configuration shown in FIG. 5 is transmitted.

If there is no corresponding ID (NO in S201), the consumption priority determination unit 12 randomly selects any one ID, giving priority to the ID whose consumption priority is “LOW” in the determination results up to step S104 (S202). That is, if there are one or more IDs whose consumption priority is “LOW”, the ID whose consumption priority is “LOW” is selected at random. If there is no ID with a “LOW” consumption priority, an ID with a “HIGH” consumption priority is randomly selected.

The consumption priority determination unit 12 then randomly selects an ID that is not in use in the domain using the selected ID (hereinafter referred to as “selected ID”), as an ID of conversion destination in the domain (hereinafter referred to as “destination ID”) (S203). In a case where the consumption priority of the selected ID is “HIGH”, the destination ID is selected for both domains. In a case where the consumption priority of the selected ID is “LOW”, the destination ID is selected for one domain.

The consumption priority determination unit 12 changes (rewrites) the consumption priority of the selected ID in the determination results up to step S104 to “UNAVAILABLE” (S204).

The consumption priority notification unit 13 transmits notification information to which the destination ID selected in step S203 is added to the rewritten determination result to the VNF device of each domain (S105). However, the destination ID is added only to the notification information for the domain that is currently using the selected ID. Furthermore, in the notification information for the domain that is currently using the selected ID, the consumption priority of the destination ID is set to “UNAVAILABLE”.

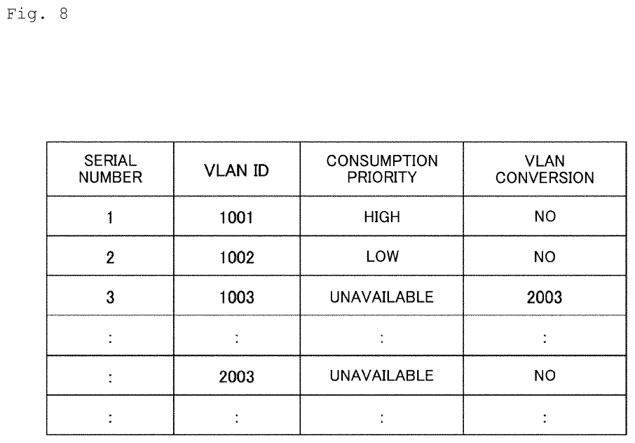

FIG. 8 is a diagram illustrating one example of notification information in the second embodiment. The notification information shown in FIG. 8 further includes a “VLAN Conversion” column in addition to items included in the notification information shown in FIG. 5. The “VLAN Conversion” column is a column indicating the destination ID for the selected ID.

In a case where the transfer device 20 of the domain that has received the notification information shown in FIG. 8 is assigned an ID of “1003” to a VLAN at an interface with the other domain, “1003” is converted to “2003” for communication related to the VLAN in its own domain.

As described above, according to the second embodiment, it is possible to connect the VLAN between domains using the VLAN conversion function even if there is no ID that is commonly available between domains, thus even sudden demands can be easily responded.

Next, a third embodiment will be described. In the third embodiment, differences from the first embodiment will be described. Features which are not referred particularly in the third embodiment may be similar to those of the first embodiment.

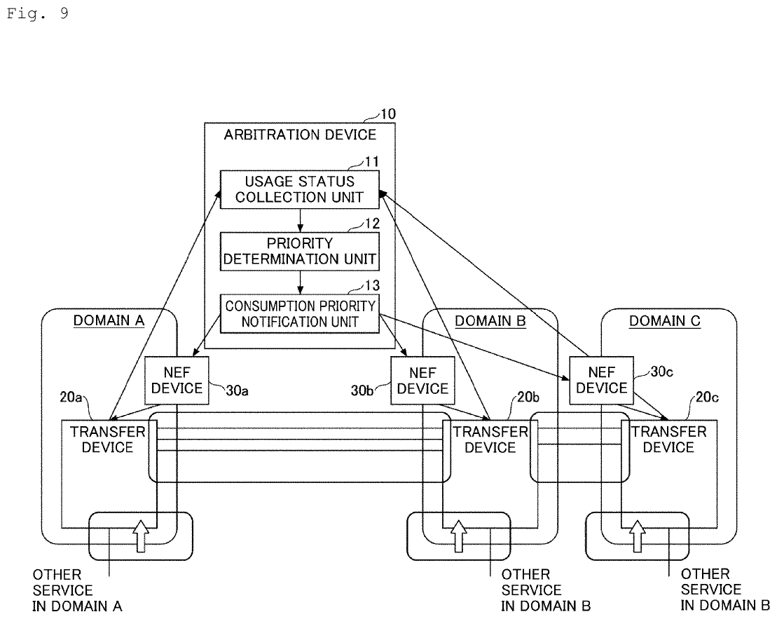

FIG. 9 is a diagram illustrating an example of a configuration of a network system according to the third embodiment. In FIG. 9, the same portions as those in FIG. 1 are designated by the same reference numerals, and the description thereof will be omitted.

As illustrated in FIG. 9, a VLAN extending over three or more domains is considered in the third embodiment. That is, in FIG. 9, a business entity domain C (hereinafter referred to as “domain C”) has been added. The domain C includes a transfer device 20c and a NEF device 30c.

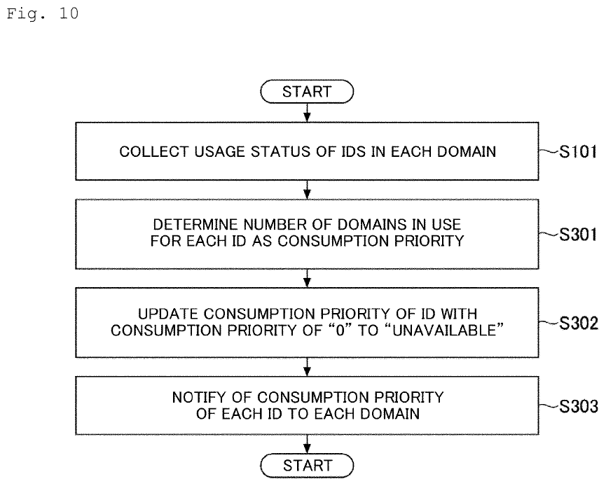

FIG. 10 is a flowchart illustrating one example of a processing procedure executed by the arbitration device 10 according to the third embodiment. In FIG. 10, the same steps as those in FIG. 3 are assigned the same step numbers, and description thereof will be omitted. In step S101, the ID usage status for the domain C is also collected.

Following step S101, the consumption priority determination unit 12 determines the number of domains in use for each ID as the consumption priority of the ID (S301). In the present embodiment, the total number of domains is three. Therefore, the consumption priority of IDs used in all domains is “3”, the consumption priority of IDs used in two domains is “2”, the consumption priority of IDs used in one domain is “1”, and the consumption priority of IDs not used in any domain is “0”.

If there is an ID whose consumption priority is “0”, the consumption priority determination unit 12 updates the consumption priority of the ID to “UNAVAILABLE” (S302).

The consumption priority notification unit 13 transmits notification information including the above determination result to each domain (S303). The notification information is transmitted to the NEF device 30 similarly to step S105 in FIG. 3.

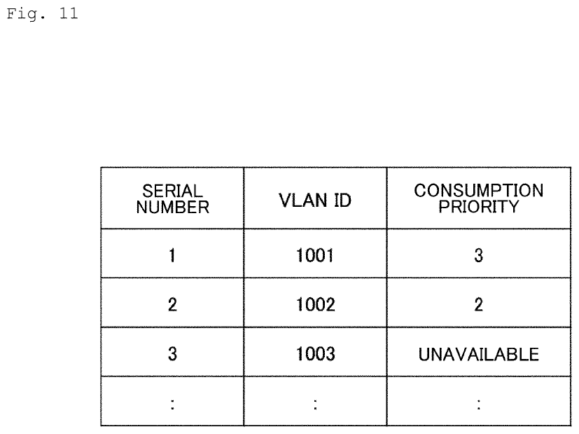

FIG. 11 is a diagram illustrating one example of notification information in the third embodiment. As shown in FIG. 11, in the third embodiment, the consumption priority of each ID is expressed by an integer. The larger the integer value is, the higher the consumption priority is (which means that it should be allocated preferentially to other services).

The third embodiment and the second embodiment may be combined. In this case, steps S201 to S205 in FIG. 7 may be executed following step S302 in FIG. 10.

According to the third embodiment, it is possible to obtain the same effects as those of each of the above embodiments as described above for three or more domains.

In the first and second embodiments, the consumption priority of each ID may be determined by the same method as in the third embodiment.

Each of the above embodiments can be applied to identification information other than the VLAN ID as long as the identification information is for virtually separating the network.

In the present embodiment, the arbitration device 10 is one example of the priority determination device. The usage status collection unit 11 is one example of the collection unit. The consumption priority determination unit 12 is one example of the determination unit.

Although the embodiments of the present invention have been described in detail above, the present invention is not limited to these particular embodiments, and various modifications and changes are possible without departing from the gist of the present invention described in accompanying claims.

### REFERENCE SIGNS LIST

10: Arbitration device

11: Usage status collection unit

12: Consumption priority determination unit

13: Consumption priority notification unit

20a 20b, 20c: Transfer device

30a, 30b, 30c: NEF device

100: Drive device

101: Recording medium

102: Auxiliary storage device

103: Memory device

104: CPU

105: Interface device

B: Bus

1. A priority determination device, comprising:
a processor; and
a memory storing program instructions that cause the processor to:
collect a usage status of identification information for virtually separating a network from each of a plurality of transfer devices distributed in a plurality of domains; and
determine a priority of use in each of the plurality of domains for each value which is available as the identification information, based on the collected usage status.

2. The priority determination device according to claim 1, wherein the program instructions cause the processor to give higher priority to a value with a larger number of domains in use.

3. The priority determination device according to claim 1, wherein the program instructions cause the processor to, if there is no value that is unused in all domains, set a priority of one of the values to the lowest, and select a value that is not used in a domain that is currently using the value with the lowest priority as a destination value.

4. A priority determination method, executed by a computer, the priority determination method comprising:
collecting usage status of identification information for virtually separating a network from each of a plurality of transfer devices distributed in a plurality of domains; and
determining a priority of use in each of the plurality of domains for each value which is available as the identification information, based on the collected usage status.

5. The priority determination method according to claim 4, wherein the determination includes giving higher priority to a value with a larger number of domains in use.

6. The priority determination method according to claim 4, wherein the determination includes setting, if there is no value that is unused in all domains, a priority of one of the values to the lowest, and selecting a value that is not used in a domain that is currently using the value with the lowest priority as a destination value.

7. A non-transitory computer-readable recording medium having stored therein a program for causing a computer to execute the priority determination method according to claim 4.
